(19) United States
(12) Patent Application Publication
(10) Pub. No.: US 2008/0256794 A1
(43) Pub. Date: Oct. 23, 2008

(54) Method For the Production of a Piston Ring For Internal Combustion Engine and a Piston Ring of this Type

(76) Inventor: Kurt Maier, Leonberg (DE)

Correspondence Address: COLLARD & ROE, P.C., 1077 NORTHERN BOULEVARD, ROSLYN, NY, 11576, US

(21) Appl. No.: 11/991,239

(22) PCT Filed: Aug. 31, 2006
(86) PCT No.: PCT/DE2006/001531

§ 371 Date: Jun. 16, 2008

(30) Foreign Application Priority Data
Sep. 1, 2005 (DE) 10 2005 041 408.7

(51) Int. Cl. B23P 15/06; F16J 9/12

(52) U.S. Cl. 29/888.07; 277/434

(57) ABSTRACT

The present invention relates to a method for manufacturing a piston ring (10) for internal combustion engines, having the following method steps:—machining of a metal strip (20), with the result that it acquires at least one beveled face (15, 16) which represents at least one part of a ring flank of the piston ring (10) which is to be manufactured,—formation of a piston ring (10) from the metal strip (20) which has been machined in this way and the surface of which forms an inner and an outer circumferential face (11, 12) and an upper and a lower ring flank,—hardening of the surface of the piston ring (10). Furthermore, the present invention relates to a piston ring (10) for internal combustion engines, the surface of which forms an inner and an outer circumferential face (11, 12) and an upper and a lower rink flank, wherein the surface is provided with a uniformly thick hardened layer (21).

The present invention relates to a method for the production of a piston ring for internal combustion engines, and to a piston ring of this type.

Piston rings having a trapezoid cross-section, in which the ring height at the outer circumference surface is greater than on the inner circumference surface, are also referred to as keystone piston rings. A piston ring in which one ring side is configured to be parallel to the inner and outer circumference surface, while the other ring side runs at an angle to them, is referred to as a half keystone ring. A piston ring in which the two ring sides run at an angle to the circumference surfaces is called a keystone ring. Such piston rings are preferably used in diesel engines as the uppermost piston ring (top ring), whereby the related piston ring groove is also configured in trapezoid shape. This is because diesel engines tend to deposit hard residues that contain carbon in the uppermost piston ring groove, which can lead to sticking of the piston rings and therefore to functional failures. Because of the trapezoid shape of the uppermost piston ring and its piston ring groove, sticking is prevented, in normal cases, and thus the sealing function of the piston ring is guaranteed.

In the production of rectangular rings for pistons of internal combustion engines, it is known to apply a nitride layer onto the entire surface of the piston ring, by means of a nitriding process, in order to harden the surface and thus to obtain better friction-wear resistance. The friction-wear resistance of the working surface of the piston rings can be further increased by means of applying additional coatings. For example, a piston ring having a rectangular cross-section is known from the German Offenlegungsschrift [examined patent published for public scrutiny] DE 35 06 746 C2, whose ring body is provided with a nitride layer over its entire surface, which layer is composed of a diffusion layer and a connection layer that lies on top of the latter. The connection layer is removed from the subsequent working surface, and a tribological coating is applied.

The European Offenlegungsschrift EP 0 605 223 A1 describes a piston ring whose surface is hardened by means of gas nitriding. Another metal nitride layer is applied to the subsequent working surface, above the gas nitride layer, as a tribological layer. The German Offenlegungsschrift DE 102 07 148 A1 also describes a piston ring having a nitride layer composed of a diffusion layer and a connection layer, whereby a deposition layer of hard ceramic is provided on the subsequent working surface, after removal of the diffusion layer.

In the production of half keystone rings and keystone rings made of steel, one conventionally proceeds from a steel strip having a rectangular cross-section, from which a ring having a rectangular cross-section is formed. This ring is processed mechanically and subjected to a hardening process, particularly a nitriding process. After removal of the connection layer that is formed during the nitriding process, along with the diffusion layer, and further mechanical precision processing, a tribological layer is generally applied to the outer circumference layer. In the last step, the ring sides are ground at an angle, and in this way, a trapezoid cross-section of the ring is produced. In this connection, the hardened layer, for example the nitride layer, is removed from the ring sides once again, in whole or in part, as a function of the trapezoid angle.

The half keystone rings or keystone rings produced in this manner, however, demonstrate increased friction-wear damage (so-called “fretting”) at the ring sides during engine operation. In this connection, additional carbonization can also be found. This is particularly observed at high ignition pressures of 200 bar to 220 bar. This damage increases with the period of use of the piston rings, and finally leads to their failure. It has furthermore been shown that this damage is location-dependent, i.e. it can occur with different intensity along the circumference of the ring sides. This damage occurs more frequently, in particular, at those locations where the nitride layer was removed.

The present invention is therefore based on the task of making available a method for the production of a piston ring, as well as a piston ring of this type, with which the occurrence of ring side damage in half keystone rings and/or keystone rings during engine operation is prevented, to a great extent.

The solution consists in a method having the characteristics of claim 1. According to the invention, the following method steps are provided:
processing of a metal strip so that it is given at least one slanted surface, which represents at least part of the ring side of the piston ring to be produced,
formation of a piston ring from the metal strip processed in this manner, the surface of which ring forms an inner and an outer circumference surface as well as an upper and a lower ring side,
hardening of the surface of the piston ring.

The piston ring according to the invention, whose surface forms an inner and an outer circumference surface as well as an upper and a lower ring side, is characterized in that the surface is provided with a hardened layer having a uniform thickness.

By means of the method according to the invention, half keystone rings and/or keystone rings having friction-wear-resistant ring sides are created, which demonstrate significantly reduced friction-wear damage (so-called “fretting”) in engine operation, as compared with the state of the art. By means of the production of a trapezoid cross-section of the metal strip before the production of the piston ring, particularly before the hardening process, it is possible to produce a uniform hardened layer having a uniform depth on the ring sides of the half keystone ring or keystone ring. In this way, uniformly high hardness values are obtained, so that essentially no friction-wear damage that impairs the piston ring function occurs any longer, along the circumference of the ring flanks. Likewise, micro-welding between piston and piston ring is effectively prevented.

Advantageous further developments are evident from the dependent claims. A steel strip having a rectangular cross-section, for example, is used as the base material for the piston ring according to the invention. This steel strip preferably consists of martensite steel having a content of 12 to 17 wt.-% chrome. If a nitriding process is selected for hardening the surfaces, a nitride zone in which hard chrome nitrides are additionally embedded is formed.

In accordance with the invention, the metal strip is transformed into a trapezoid cross-section by means of cutting or non-cutting processing, for example, preferably by means of grinding, for example of the upper and/or lower broad side flanks of a metal strip having a rectangular cross-section, to produce slanted surfaces. The surface or surfaces processed in this manner are later supposed to form the ring side or ring sides of the piston ring to be produced. In this connection, it is advantageous if regions that continue to run parallel to one another are maintained next to the slanted surface(s). The width of the regions that run parallel to one another preferably amounts to a maximum of one-fourth of the total width of the steel strip. The regions that run parallel to one another can serve as stacking surfaces for packeting of the half keystone rings and/or keystone rings during subsequent processing of the piston rings.

Both an endless metal strip and a cut piece can be used and processed for the method according to the invention, in order to obtain the at least one slanted surface. When using an endless metal strip, the processing can take place in a continuous process. In further work steps, which are actually known, the metal strip, which is now trapezoid in cross-section, is formed into a piston ring, cut to the required length, if necessary, if an endless metal strip is used, and then subjected to further processing, particularly mechanical processing of the surfaces, for example, and/or to heat treatment.

To harden the surface of the piston ring, nitriding or chrome nitriding methods that are actually known are preferably used. Subsequently, a friction-wear protection layer, preferably a chrome layer or a chrome nitride layer, can additionally be applied to the lower ring sides of the piston ring, since experience has shown that the lower ring sides are subject to particularly great stress.

Furthermore, an additional friction-wear protection layer or tribological layer, preferably a chrome nitride layer or a manganese phosphate layer, can be applied to the outer circumference surface or working surface of the piston ring, in order to increase the useful lifetime of the half keystone rings or keystone rings. For applying the friction-wear protection layer or tribological layer, the half keystone rings or keystone rings are stacked to form a packet, preferably under axial bias. In this way, application of the friction-wear protection layer to the ring sides, as well, is prevented, if this is not desired.

An exemplary embodiment of the invention will be described in greater detail in the following, using the attached drawings. These show:

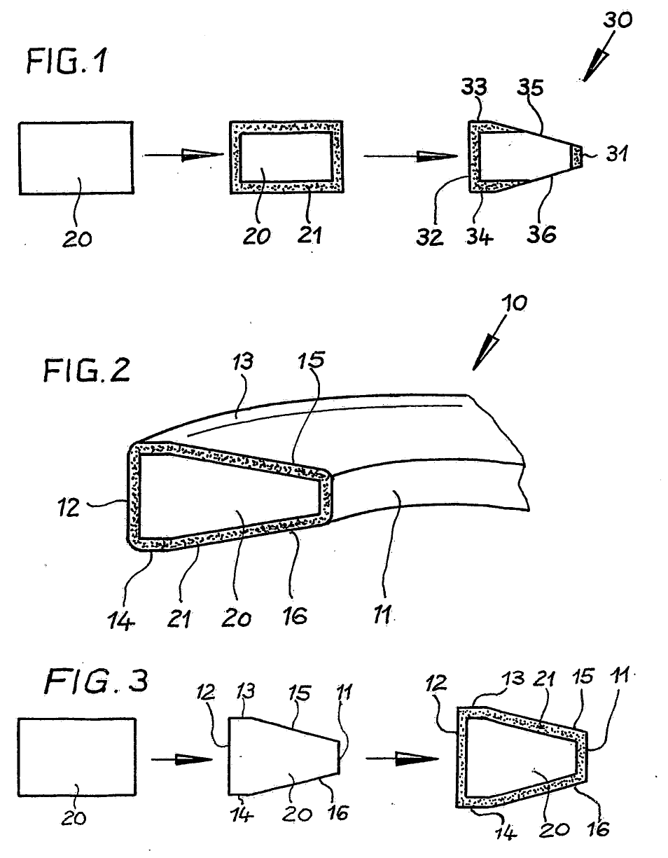

FIG. 1 a schematic representation of the production method for a keystone ring, in accordance with the state of the art;

FIG. 2 a schematic representation of a keystone ring produced in accordance with the method according to the invention;

FIG. 3 a schematic representation of the production method according to the invention for a keystone ring;

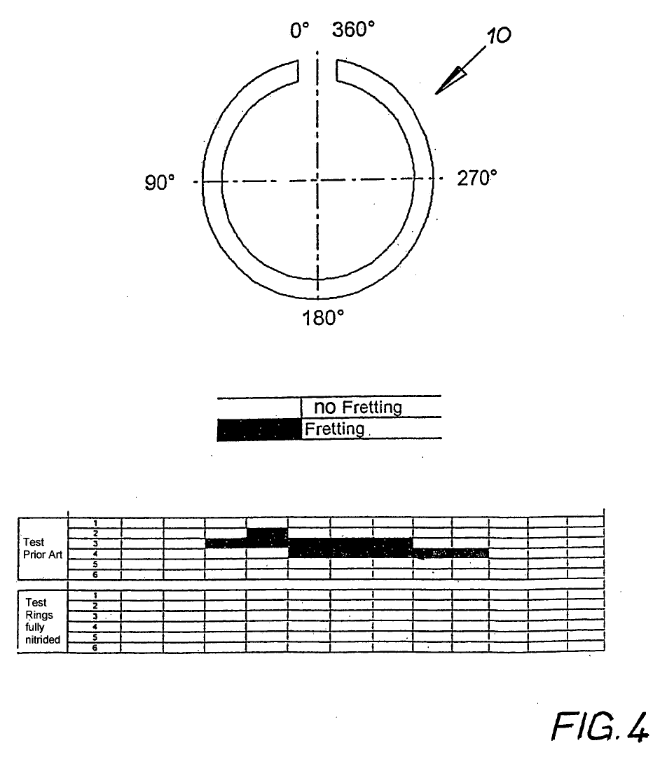

FIG. 4 a representation of the location-dependent friction wear damage on the ring sides of a keystone ring in accordance with the state of the art, on the one hand, and in accordance with the invention, on the other hand.

FIG. 1 once again shows the production of a piston ring 30, a keystone piston ring in accordance with the state of the art. The following explanations apply analogously, of course, also for half keystone rings. A piston ring 30 is formed from a steel strip 20, in known manner. After a first mechanical processing that includes parallel grinding of the ring sides, surface hardening, typically nitriding, takes place. In this connection, a hardened layer 21 forms along the surface of the piston ring 30, in this case a nitride layer composed of a diffusion layer and a connection layer. After further mechanical processing, which particularly serves for removing the connection layer, the outer circumference surface 32 is provided with a friction-wear protection layer (not shown). For applying the friction-wear protection layer, the piston rings 30 are stacked to form a packet, preferably under axial bias. In this way, application of the friction-wear protection layer to the ring sides, as well, is prevented, since this is generally not desired. At the end, the piston ring 30 is processed to give it the desired shape of a half keystone ring or keystone ring. For this purpose, the ring sides are generally ground away at a flat angle, at least in part, so that slanted upper and lower ring sides 35, 36 are formed, which follow parallel upper and lower regions 33, 34. The outer circumference surface 32 and the inner circumference surface 31 of the piston ring 30 remain as before. As a result of this method of shaping, the hardened layer 21 is at least partially removed along the upper and lower ring side.

FIG. 2 schematically shows a keystone ring 10 that has been produced in accordance with the method according to the invention, as schematically shown in FIG. 3. Here again, it holds true that the following explanations apply analogously also for a half keystone ring. The starting material, as shown in FIG. 1, for example, is a martensite steel strip 20 (chrome content 12 to 17 wt.-%) having a rectangular cross-section. This steel strip 20, which can be an endless steel strip or a cut piece, is converted to a trapezoid cross-section in a first work step. A suitable method is grinding of the upper and lower broad sides of the steel strip 20. Alternatively to grinding, the steel strip can also be reshaped into a trapezoid cross-section by means of cold-rolling of the broad sides. In the exemplary embodiment, slanted surfaces 15, 16 are formed, along with a higher narrow side 12 and a lower narrow side 11, whereby surfaces 13, 14 that run parallel to one another are maintained, which follow the slanted surfaces 15, 16 and the higher narrow side 12. In the exemplary embodiment, the surfaces 13, 14 that run parallel to one another serve to ensure stackability of the piston rings, which is advantageous in some of the subsequent processing steps. Their width amounts to as much as one-fourth, preferably less than one-fourth of the width of the steel strip 20, for example.

Now the steel strip 20 processed in this manner is formed into a piston ring 10, by means of suitable devices, in known manner, and cut off, if necessary, whereby the higher narrow side of the steel strip 20 is converted into the outer circumference surface 12, and the lower narrow side of the steel strip 20 is converted into the inner circumference surface 11 of the piston ring 10. The surfaces 13, 15 form the upper ring side, and the surfaces 14, 16 form the lower ring side of the piston ring 10.

The piston ring 10 therefore already has a trapezoid cross-section after this production step.

The internal tensions in the material of the piston ring 10 that result from cold deformation are subsequently relieved in a thermal treatment. Further processing and surface treatment of the piston ring 10 takes place in known manner. After a first mechanical processing (grinding, brushing, cleaning, etc.), the piston ring 10 is subjected to a hardening process. Preferably, the piston ring 10 is nitrided over its entire surface by means of a known gas nitriding process, so that a circumferential nitride layer 21 is formed, which consists, in the exemplary embodiment, of a diffusion layer and a connection layer, whereby the nitride hardness depth in the diffusion layer can be as great as 200 μm. The connection layer possesses a Vickers hardness of 700 HV 0.05 at a layer thickness of approximately 5 to 10 μm, for example. If the steel strip 20 contains chrome, hard chrome nitrides are formed during nitriding.

After nitriding, the connection layer is removed from the surface of the piston ring 10, i.e. from the outer circumference surface and from the ring sides of the piston ring 10, by means of grinding, for example. Now, in principle, the desired piston ring 10 is present, in the exemplary embodiment in the form of a keystone ring.

Optionally, in order to further improve the friction-wear properties, a chrome or chrome nitride layer can be applied, preferably to the lower ring side having the surfaces 14, 16, by means of a known PVD method (physical vapor deposition), since the greatest friction-wear damage has been shown to occur there, particularly in the case of the keystone piston rings produced in accordance with the state of the art.

A friction-wear protection layer or tribological layer is applied to the outer circumference surface 12, which corresponds to the subsequent working surface of the piston ring 10. A chrome nitride layer is vapor-deposited in known manner, for example by means of a PVD method, avoiding any deposition onto the surfaces 13, 14, 15, 16 of the ring sides. In the exemplary embodiment, a chrome nitride layer has a thickness between 10 and 40 μm and a Vickers hardness between 1200 HV 0.05 and 1800 HV 0.05.

Alternatively to this, a galvanic hard chrome layer or a thermal injection-molded layer or a manganese phosphate layer can also be applied to the outer circumference surface 12.

It is practical if coating of the outer circumference surface 12 and subsequent working surface of the piston ring 10 takes place in the stacked and axially biased state of multiple piston rings 10. In this way, it is particularly guaranteed that the surfaces 13, 14, 15, 16 of the ring sides are not coated with the friction-wear protection layer or tribological layer to be applied during the coating process.

FIG. 4 shows a representation of the local friction-wear damage on the circumference side for a 6-cylinder diesel engine, at an operating period of 100 hours under full load, for a piston ring according to the state of the art, on the one hand, and for a piston ring 10 produced according to the invention, in the form of a keystone ring, on the other hand. The graphic shows that the piston ring 10 produced according to the invention shows clearly less friction-wear damage on the ring sides, as compared with the state of the art.

1. Method for the production of a piston ring (10) for internal combustion engines, having the following method steps:
processing of a metal strip (20) so that it is given at least one slanted surface (15, 16), which represents at least part of the ring side of the piston ring (10) to be produced,
formation of a piston ring (10) from the metal strip (20) processed in this manner, the surface of which ring forms an inner and an outer circumference surface (11, 12) as well as an upper and a lower ring side,
hardening of the surface of the piston ring (10).

2. Method according to claim 1, wherein a steel strip (20) having a rectangular cross-section is used as the metal strip.

3. Method according to claim 2, wherein a steel strip made of martensite steel, having a content of 12 to 17 wt.-% chrome is used.

4. Method according to claim 1, wherein the at least one slanted surface is obtained by means of cutting or non-cutting processing.

5. Method according to claim 1, wherein two slanted surfaces are formed, which represent at least part of the two ring sides of the piston ring to be produced.

6. Method according to claim 1, wherein an endless metal strip or a cut piece is processed in order to obtain the at least one slanted surface.

7. Method according to claim 1, wherein in order to form the piston ring, the processed metal strip is formed into a piston ring, cut to the required length, if necessary, and heat-treated and/or mechanically processed.

8. Method according to claim 1, wherein a nitriding process or chrome nitriding process is used to harden the surface of the piston ring.

9. Method according to claim 1, wherein a friction-wear protection layer, preferably a chrome layer or a chrome nitride layer, is applied to the lower ring sides (14, 16) of the piston ring after hardening.

10. Method according to claim 1, wherein a friction-wear protection layer or tribological layer, preferably a chrome nitride layer or a manganese phosphate layer, is applied to the outer circumference surface (12) or working surface of the piston ring.

11. Method according to claim 9, wherein the piston rings are stacked into a packet, under axial bias, for applying the friction-wear protection layer or tribological layer.

12. Piston ring (10) for internal combustion engines, whose surface forms an inner and an outer working surface (11, 12), as well as an upper and a lower ring side, wherein the surface is provided with a hardened layer (21) having a uniform thickness.

13. Piston ring according to claim 12, wherein the upper and lower ring side each have a surface region (13, 14) that runs parallel to one another and a surface region (15, 16) that runs at a slant.

14. Piston ring according to claim 13, wherein the width of the surface regions (13, 14) that run parallel to one another amounts to maximally one-fourth of the width of the piston ring (10).

15. Piston ring according to claim 12, wherein a friction-wear protection layer, preferably a chrome layer, is applied to the surfaces (14, 16) of the upper and/or lower ring sides, on top of the hardened layer (21).

16. Piston ring according to claim 12, wherein a friction-wear protection layer or tribological layer, preferably a chrome nitride layer or a manganese phosphate layer, is applied to the outer and/or inner circumference surface (12) of the piston ring (10), on top of the hardened layer (21).

17. Piston ring (10) for internal combustion engines, produced in accordance with a method according to claim 1.
